(19) United States
(12) Patent Application Publication
(10) Pub. No.: US 2007/0275348 A1
(43) Pub. Date: Nov. 29, 2007

(54) Sonic and Ultrasonic Surgical Tips

(76) Inventor: Ronald R. Lemon, Metairie, LA (US)

Correspondence Address: PATENT DEPARTMENT;TAYLOR, PORTER, BROOKS & PHILLIPS, L.L.P, P.O. BOX 2471, BATON ROUGE, LA, 70821-2471, US

(21) Appl. No.: 10/575,735

(22) PCT Filed: Oct. 22, 2004
(86) PCT No.: PCT/US04/35344

§ 371 Date: Jul. 6, 2007

Related U.S. Application Data
(63) Continuation of application No. 60/513,835, filed on Oct. 23, 2003.

(51) Int. Cl. A61C 1/07

(52) U.S. Cl. 433/119; 606/53

(57) ABSTRACT

Surgical instruments that enhance the overall performance of medical, endodontic, and dental surgical procedures have been discovered. In one embodiment, the surgical instruments are tool tips coupled to a sonically or ultrasonically-vibrating member using a universal tip holder having an irrigation spout that flushes a surgical site area with water to remove hemorrhage or other surgical debris from the surgical site and the tool tip, in addition to removing heat from the tool tip. In another embodiment, the surgical instruments are tool tips having a built-in irrigation spout and a coupling end for coupling the tool tips to a sonically or ultrasonically-vibrating member. Each surgical instrument has a tool tip adapted to perform a specific surgical function, e.g., elevating periosteum, removing bone, removing vascular soft tissue mass around the ends of teeth and bones, performing an apicoectomy, and removing a tooth or sections of a tooth.

The benefit of the filing date of provisional U.S. application Ser. No. 60/513,835, filed 23 Oct. 2003, is claimed under 35 U.S.C. § 119(e)

### TECHNICAL FIELD

This invention pertains to sonic and ultrasonic tips that can be used to enhance the overall performance of surgical procedures (e.g., medical, endodontic, and dental).

The advantages associated with ultrasonic treatment in medical, endodontic, and dental surgeries are generally known. However, many dentists, endodontists, and physicians still rely on antiquated surgical devices actuated by hand or mechanical means (e.g., electrical or air-driven drills and saws) to perform surgical procedures. Many of these devices obstruct visibility of the surgical site, and may even cause injury to surrounding healthy tissues, teeth, and bones.

For example, in a dental surgical procedure to repair a failing root canal, elevation of gingival tissue from underlying cortical bone is typically required to access the diseased area. Gingival tissue is attached to cortical bone by a membrane of connective tissue, the periosteum. The instruments (e.g., a periosteal elevator) that are currently used to elevate the gingival tissue often tear or rip the periosteal tissue causing excessive bleeding.

A second example in dental surgery occurs when trying to access structures beneath the cortical bone such as a diseased root tip. Removal of cortical bone is usually done with rotating dental instruments such as burs powered by electric or air-driven devices. These rotating dental instruments often clog with surgical debris during cutting procedures reducing cutting efficiency and generating excessive heat, which may damage healthy bone and soft tissue. In addition, the size of these rotating dental instruments obstructs vision of the surgical site.

A third example is the evaluation of the condition of a root end and preparation for treatment. Soft tissue surrounding the root end must be removed, which is usually done with scoop or spoon-shaped surgical instruments such as a curette actuated by hand. Removal of soft tissue mass using these instruments is difficult because the tissue tends to adhere to surrounding bone. In addition, these instruments often tear and fragment the soft tissue from surrounding bones, which causes excessive bleeding that impedes visibility of the surgical site and which fragments the specimen for biopsy.

A fourth example occurs when preparing a tooth for placement of filling material (e.g., silver amalgam, gutta percha, cements based on zinc oxide eugenol, composite materials, mineral trioxide aggregate, etc.) to seal the open cavity and inhibit the reoccurrence of periapical infection. An apicoetomy (i.e., beveling of the root tip of a tooth) often must be performed before the filling material can be injected into the tooth. This beveling is usually done with rotating dental instruments such as burs powered by electricity or air. As previously mentioned, these rotating dental instruments often clog with surgical debris during cutting procedures reducing cutting efficiency and generating excessive heat, which may damage healthy teeth and soft tissue. In addition, these rotating dental instruments obstruct vision of the surgical site during use.

A final example is the removal of an untreatable tooth. Removal of the tooth or sections of the tooth is done with dental instruments having a narrow, flat tip with curved side edges for loosening the tooth from the socket, e.g., a manual elevator actuated by hand. Removal of a tooth using these instruments requires a significant expansion of the bony housing surrounding the root, which may damage the root.

### BACKGROUND ART

The following publications describe some devices currently used for performing dental surgical procedures.

U.S. Publ. No. 2003/0003418 and U.S. Pat. No. 4,608,019 describe devices for separating a tooth from a surrounding bony housing, comprising a hand-piece having a vibrating member and a contact blade connected to the vibrating member. In one embodiment, the tooth is separated from alveolar bone by cutting the periodontal membrane interposed between the tooth and the alveolar bone with the contact blade.

U.S. Pat. No. 6,267,594 describes a device for removing human or animal body tissue, or artificial parts, comprising a hand-piece with a high frequency vibrator, a tool having an abrasive working surface, and a holding device connecting the vibrator to the tool. In one embodiment, the tool is spatula-shaped with saw-like cutting edges that incise and remove material on a thin or line-like strip.

U.S. Pat. No. 6,273,717 describes a device and method for fabricating a sonic or ultrasonic dental instrument having a soft and flexible surface for cleaning teeth, removing hardened bacterial masses from teeth, and treating periodontal gum disease, comprising a shank and treatment sections with various shapes, e.g., a linear probe shape, a bud shape, spade shape, curette shape, and a curved probe shape.

Japanese Publication No. 200262540 describes a device for reducing the force required to extract a tooth by transferring vibration energy to the interalveolar clearances around the root of a tooth to ease the expansion of the alveoli and to float the root, comprising an elevator having a bill portion, an ultrasonic vibrator for vibrating the bill portion, a support portion, a connection portion, and a grip portion.

U.S. Pat. No. 5,704,787 describes a device and method for hardening an ultrasonic dental surgical tip for cutting or abrading. The device is a surgical tip for use with an ultrasonic instrument comprising an elongated instrument, wherein the outer surface has multiple indentations for forming a cutting surface and a metal nitride coating to maintain its cutting characteristics.

U.S. Pat. No. 5,577,911 describes a device and method for separating and removing diseased granulation tissue from a periodontal cavity comprising a curette having a spoon-shaped end portion with a rounded tip and sharp edges rigidly affixed to an ultrasonic energy source.

U.S. Design Pat. No. 342,313 illustrates an ornamental design for an ultrasonic cutting osteotome used to remove bone segments.

U.S. Pat. No. 2,990,616 describes devices and methods for adapting the devices for use with hand-operated ultrasonic devices, comprising a cutting tool, having a base section rigidly attached to a tool tip holder for injecting longitudinal vibrations in the base section, and a tip section that merges into the base section. In one embodiment, the cutting tool cuts and laterally enlarges a cavity space in a tooth.

### DISCLOSURE OF INVENTION

I have discovered devices that enhance the overall performance of medical, endodontic, and dental surgical procedures (e.g., surgical treatment of a failing root canal). The devices are surgical instruments having two basic designs. In one embodiment, the surgical instruments (e.g., a bone remover and a tooth remover) are tool tips coupled to a sonically or ultrasonically-vibrating member using a universal tip holder having an irrigation spout that flushes a surgical area with water to remove hemorrhage or other surgical debris (e.g., soft tissues, teeth, or bone) from the surgical site and the tool tip, in addition to cooling the area. The universal tip holder allows the quick and inexpensive interchanging and coupling of different types of tips or of worn tool tips to the sonically or ultrasonically-vibrating member. In another embodiment, the surgical instruments (e.g., a periosteal elevator, a curette, a root tip elevator, and a root elevator) are tool tips having a built-in irrigation spout and a coupling end for coupling the tool tips to a sonically or ultrasonically-vibrating member. Both designs allow for the transmittance of oscillations from the vibrating member to the tool tip at frequencies sufficient to achieve pre-specified surgical objectives. In another embodiment, the surgical instruments (e.g., root elevator and root tip elevator) are tool tips having a dampener adapted to inhibit the transference of sonic or ultrasonic-vibrational energy and heat generated at the cutting surface of the tool tip to surrounding health tissues, bones, and teeth.

### BRIEF DESCRIPTION OF THE DRAWINGS

FIG. 1A illustrates a perspective view of one embodiment of a straight-shaped ultrasonic bone remover.

FIG. 1B illustrates a perspective view of one embodiment of a curve-shaped ultrasonic bone remover.

FIG. 2A illustrates a perspective view of one embodiment of a straight-shaped ultrasonic tooth cutter.

FIG. 2B illustrates a perspective view of one embodiment of a curve-shaped ultrasonic tooth cutter.

FIG. 3A illustrates a top plan view of one embodiment of an ultrasonic curette.

FIG. 3B illustrates a side view of the ultrasonic curette shown in FIG. 3A.

FIG. 4 illustrates a perspective view of one embodiment of an ultrasonic periosteal elevator.

FIG. 5 illustrates a perspective view of one embodiment of an ultrasonic root elevator.

FIG. 6 illustrates a perspective view of one embodiment of an ultrasonic root tip elevator.

The general purpose of this invention is to provide reliable, inexpensive devices that enhance the overall performance of surgical procedures. The invention can be used to improve the performance of surgical instruments used in medical, endodontic, and dental surgeries, including periosteal elevators, bone removers, curettes, tooth-cutters, and root elevators. In one embodiment, the surgical instruments comprise a tool tip having a treatment section, a shaft, an irrigation spout, and a coupling end. The coupling end is removably coupled to a sonically-vibrating member capable of transmitting oscillations to the tool tip at frequencies between 5,000 to 20,000 Hz, either in an elliptical or a longitudinal pattern, or both. Alternatively, the tool tip is actuated using an ultrasonically-vibrating member capable of transmitting oscillations to the tool tip at frequencies between 20,000 to 30,000 Hz. In another embodiment, the surgical instruments comprise a tool tip having a treatment section and a fixation end, and a universal tip holder having a transmitting end that is coupled to the fixation end, an irrigation spout, and a coupling end for removably coupling the tool tip to the sonically or ultrasonically vibrating member.

There are several advantages to using these devices. First, the potential for damaging healthy tissues and bones during a dental or medical surgical procedure is substantially reduced. The irrigation spout allows surgical procedures to be conducted without excessive generation of heat or clogging caused by the accumulation of surgical debris (e.g., severed bones and soft tissues). Third, the physical muscle fatigue of the surgeon is substantially reduced. The application of sonic or ultrasonic energy to surgical tips reduces the amount of hand pressure required to perform the surgical procedure. Fourth, visibility of the surgical site is enhanced by several methods; (1) the tool tip holder extends the tool tip away from the hand-piece for a clearer view of the surgical site; (2) the relative sizes of the tool tips can be reduced; and (3) the water flush keeps the area clean. Fifth, cost for replacing the surgical apparatuses is reduced. A universal tip holder may be used such that only the tool tip is replaced once worn.

Additional advantages for specific devices are as follows:

Ultrasonic Periosteal Elevator: The tissue is separated from surrounding teeth and bones with less tissue damage and reduced bleeding because blood vessels are surgically severed rather than tom. Additionally, smaller surgical incisions are necessary for tissue reflection.

Ultrasonic Curette: The speed at which soft tissue is removed from teeth and bones is increased, and the amount of bleeding is reduced. A more intact biopsy specimen over conventional methods is obtained because the novel apparatus lifts and displaces vascular tissue masses, rather than tearing the tissue during excision.

Ultrasonic Tooth Cutter: The damage to healthy bones surrounding the surgical site caused by the excessive generation of frictional heat and tip clogging is reduced by the continuous irrigation with water. The root tips can be beveled or removed completely by cutting through an entire root dimension.

Ultrasonic Root Elevator and Root Tip Elevator: Damage to surrounding body masses caused by the generation of vibrational energy and heat is reduced by a dampener capable of isolating heat generated at the cutting surface of the tool tip.

### MODES FOR CARRYING OUT THE INVENTION

### EXAMPLE 1

Tool Tips Connected to a Sonically or Ultrasonically-Vibrating Member Using a Universal Tip Holder

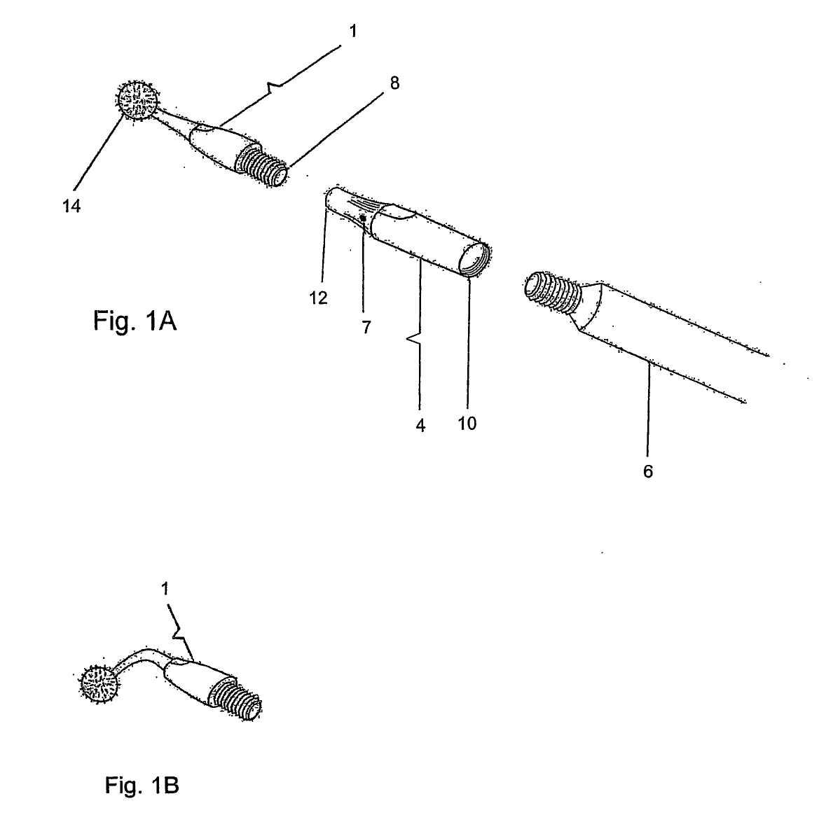

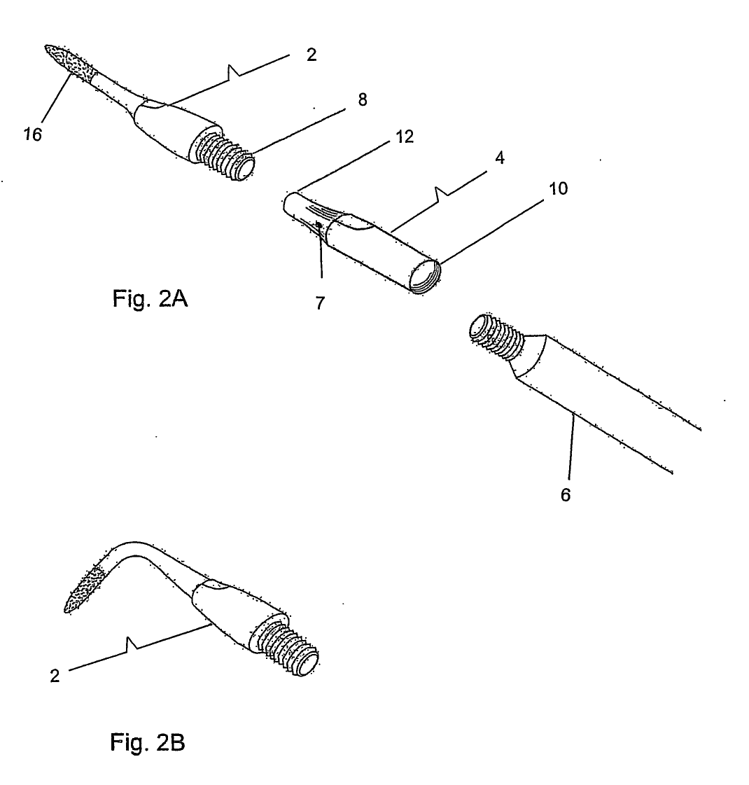

The following surgical instruments are tool tips having a fixation end 8 connected to an ultrasonically vibrating member 6 using a universal tip holder 4, in accordance with this invention. See FIGS. 1 and 2. In this embodiment, ultrasonically-vibrating member 6 is capable of adjustably transmitting ultrasonic oscillations at a frequency between about 20,000 to about 30,000 cycles per second and providing a continual supply of water to the tool tips such as a P-5 ultrasonic energy-emitting hand-piece (Satalec Company, Paris, France). Universal tip holder 4 comprises an irrigation spout 7 for spraying water near a surgical site, a coupling end 10, and a transmitting end 12, and is adapted to receive and transmit ultrasonic oscillations and a continual supply of water from vibrating member 6 to the tool tips. Irrigation spout 7 is adapted to flush a surgical site with water to remove hemorrhage or other surgical debris (e.g., soft tissues, teeth, or bone) and heat from the surgical site and the tool tips. To facilitate the quick and inexpensive interchanging of different types of tool tips, coupling end 10 is adapted to be removably coupled to vibrating member 6, and transmitting end 12 is adapted to be removably coupled to fixation end 8. The following examples are tool tips used in conformity with this embodiment

Ultrasonic Bone Remover

FIGS. 1A and 1B illustrate two examples of tool tips 1 attached to a universal tip holder 4, in accordance with this invention. Tool tip 1, as shown in FIG. 1A, is a straight-shaped ultrasonic bone remover having a treatment section 14 similar in shape to a commercially available diamond-coated bur (e.g., a #4 and a #6 round high speed diamond burs (Endoco, Inc., Memphis, Tenn.); and a 801 round diamond #5801-11 coarse bur (Brasseler USA, Savannah, Ga.)). Tool tip 1 is capable of abrading away portions of a bone in a predetermined pattern to minimize the generation of frictional heat and the potential for clogging of treatment section 14. Alternatively, the bur may be coated with cubic zirconia or steel chips to improve cutting efficiency during ultrasonic or sonic activation. Tool tip 1, as shown in FIG. 1B, is a curve-shaped bone remover adapted to access surgical sites unreachable with a straight-shaped ultrasonic bone remover.

Ultrasonic Tooth Cutter

FIGS. 2A and 2B illustrate a third example of a tool tip attached to a universal tip holder 4, in accordance with this invention. Tool tip 2, as shown in FIG. 2A, is a straight-shaped, ultrasonic tooth cutter having a treatment section 16 similar in shape to a commercially available diamond-coated bur (e.g., a round end tapered diamond S. Course #5805-016 and a flat end cylinder diamond S. Course #5835-010 bur; Brassler USA, Savannah, Ga.). Tool tip 2 is capable of abrading away portions of a tooth, including beveling the root tip of a tooth and removing the whole root tip, to minimize the generation of frictional heat and the potential for clogging of the treatment section 16. Alternatively, the bur may be coated with cubic zirconia or steel chips to improve cutting efficiency during ultrasonic or sonic activation. Tool tip 2, as shown in FIG. 2B, is a curve-shaped ultrasonic tooth cutter adapted to access surgical sites unreachable with a straight-shaped ultrasonic tooth cutter. Other embodiments of the ultrasonic tooth cutter may be adapted for the generalized cutting (dental or medical) of calcified human tissues such as bones, ligaments and cartilage.

### EXAMPLE 2

Tool Tips Connected Directly to a Sonically or Ultrasonically-Vibrating Member

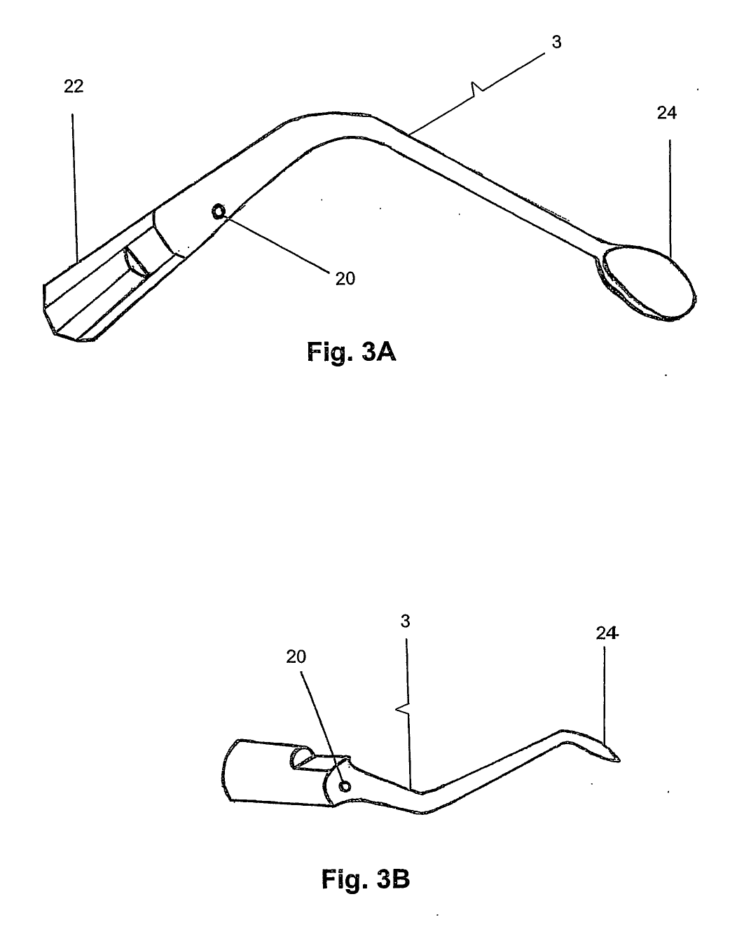

The following surgical instruments are tool tips having a built-in irrigation spout 20 and a coupling end 22 for coupling the tool tips directly to an ultrasonically vibrating member 6, in accordance with this invention. (See FIGS. 3-6) In this embodiment, ultrasonically-vibrating member 6 is again capable of adjustably transmitting ultrasonic oscillations at a frequency between about 20,000 to about 30,000 cycles per second and providing a continual supply of water to tool tips, e.g., a P-5 ultrasonic energy-emitting hand- piece (Satalec Company, Paris, France). Irrigation spout 20 flushes a surgical site area with water to remove hemorrhage or other surgical debris (e.g., soft tissues, teeth, or bone) and heat from the surgical site and the tool tips. The following examples are tool tips used in conformity with this embodiment.

Ultrasonic Curette

FIGS. 3A and 3B illustrate two examples of a tool tip, in accordance with this invention. FIG. 3A is a top plan view of one embodiment of an ultrasonic Curette. Tool tip 3, as shown in FIG. 3A, was an L-shaped ultrasonic curette having an approximately 180° spoon-shaped treatment section 24 adapted to avoid the tearing of soft tissue masses to expose the surgical site by controllable lifting and displacing soft tissue masses in close proximity with teeth and bones, such that upon completion of the surgical procedure, the tissue masses may be repositioned. Treatment section 24 is similar in shape to a commercially available curette (e.g., Lucas #86 and Miller #10 currettes; Hu-Friedy Dental, Chicago, Ill.). FIG. 3B is a side view of the ultrasonic curette shown in FIG. 3A.

Ultrasonic Periosteal Elevator

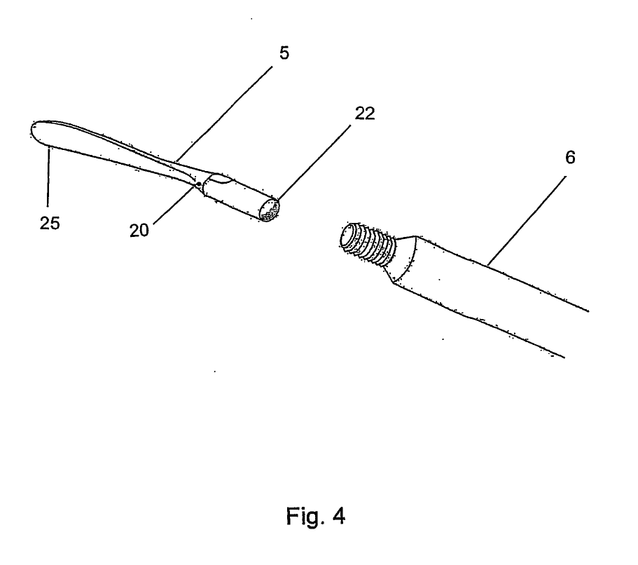

FIG. 4 illustrates a third example of a tool tip in accordance with this invention. In this embodiment, tool tip 5 was an ultrasonic periosteal elevator having a spatula-shaped treatment section 25 similar in shape to a commercially available periosteal elevator (e.g., Goldman-Fox #14, W7 Wax Spatula, and #152 K-N Periosteals; Hu-Friedy Dental, Chicago, Ill.). Tool tip 5 is capable of elevating periosteum (i.e., a membrane of connective tissue which attaches outer soft tissues, including gum tissue and skin) from teeth and bones. To achieve this, tool tip 5 is adapted to avoid the blunt dissection of soft tissue (i.e., the ripping, tearing, and damaging of soft tissue) by transmitting ultrasonically-vibrating energy to treatment section 25 such that soft tissue is surgically reflected (i.e., lifted) from surrounding bones (e.g., cortical and skeletal bones) and teeth with minimal tissue injury. Alternatively, the size and shape of tool tip 5 may be adapted to allow tissue reflection through smaller surgical incisions.

Ultrasonic Root Elevator

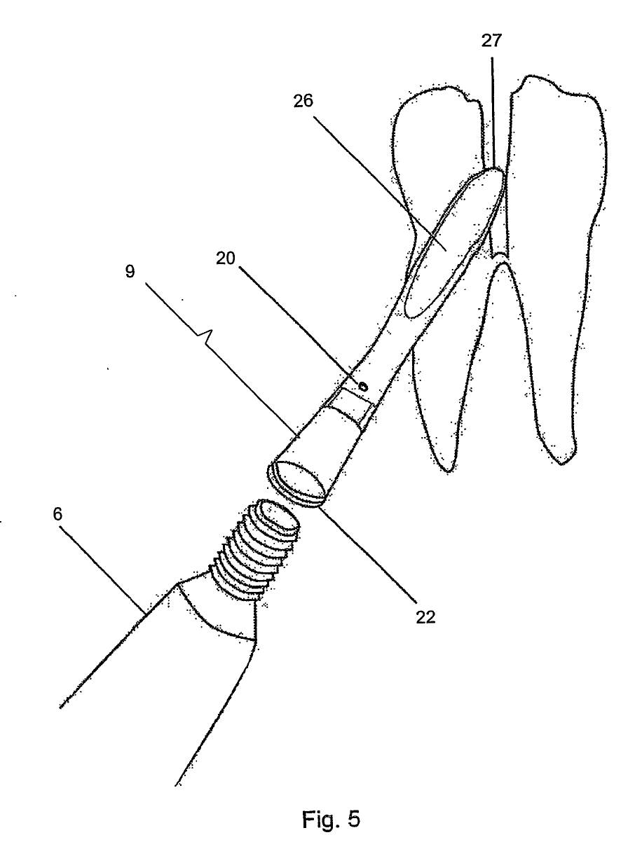

FIG. 5 illustrates a forth example of a tool tip, in accordance with this invention. In this embodiment, tool tip 9 is an ultrasonic root elevator tip having a round end, taper- shaped treatment section 27, a cutting surface (not shown), and a non-cutting surface 26. Tool tip 9 is capable of separating periodontal ligament fibers from a root surface and the bony housing surrounding a root It is similar in shape to a commercially available elevator (e.g., West #2, 3, and 4, Apical #9R and #9L, and 12M MacMillan Gouge; Hu-Friedy Dental Company, Chicago, Ill.). In an alternative embodiment, non-cutting surface 26 additionally comprises a dampener (not shown) adapted to soften the impact that the non- cutting surface 26 has on the surrounding body masses, while insulating the surrounding body masses from ultrasonic vibration and heat. The dampener is made from material such as ceramic, polytetrafluoroethylene, polyester, and polypropylene.

Ultrasonic Root Tip Elevator

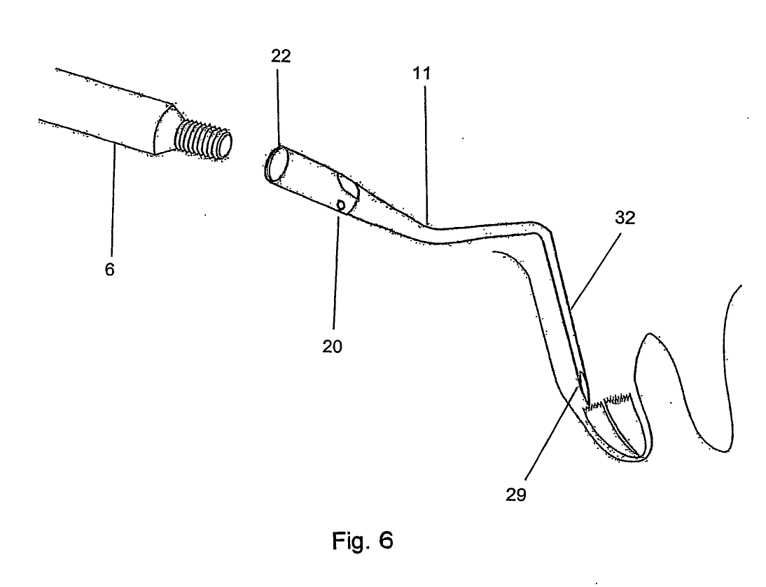

FIG. 6 illustrates a fourth example of a tool tip, in accordance with this invention. In this embodiment, tool tip 11 is an ultrasonic root tip elevator tip having a taper-shaped treatment section 29, a cutting surface (not shown), and a non-cutting surface 32. Tool tip 11 is capable of removing tooth fragments lodged in the root surface or bony housing surrounding a tooth. It is similar in shape to a commercially available elevator (e.g., #2 and #3 West; Hu-Friedy Dental Company, Chicago, Ill.). In an alternative embodiment, non-cutting surface 32 additionally comprises a dampener (not shown) adapted to soften the impact that non-cutting surface 32 has on the surrounding body masses, while insulating the surrounding body masses from ultrasonic vibration and heat. The dampener is again made from material such as ceramic, polytetrafluoroethylene, polyester, and polypropylene.

### EXAMPLE 3

Construction of the Ultrasonically-Actuated Surgical Devices

The tool tips used to test the design of the ultrasonic periosteal elevator and the ultrasonic curette were removed from a periosteal elevator (#152 K-N Periosteal; Hu-Friedy Dental, Chicago, Ill.) and a curette (Miller #10; Hu-Friedy Dental, Chicago, Ill.), respectively. Each tool tip was modified by removing the existing hand-piece attached to the tool tip, machining a coupling end to the tool tip using an ultraviolet laser-welding machine (DENTAURUM® model DL 3000; Pforzheirn, Germany), and drilling a small hole into the shaft to form an irrigation spout.

### EXAMPLE 4

Testing of the Constructed Ultrasonically-Actuated Surgical Devices

To confirm that the prototype ultrasonic periosteal elevator and the prototype ultrasonic curette were effective, clinical trials were conducted on human patients using the prototypes described in Example 3 during a root canal repair surgery. The prototype surgical devices were actuated using a P-5 ultrasonic energy-emitting hand-piece (Satalec Company, Paris, France) capable of adjustably transmitting ultrasonic oscillations at a frequency between 20,000 to 30,000 cycles per second to the tool tips and providing a continual supply of water to the surgical site.

Ultrasonic Curette

The prototype ultrasonic curette was used to temporarily displace soft tissue mass surrounding an infected bone, so that the condition of the bone surrounding the tooth root could be observed, and the root end of the diseased tooth evaluated and prepared for treatment. To achieve this, the treatment section 24 of the ultrasonic curette as described in Example 3 and shown in FIG. 4 was first placed between the soft tissue mass and the bone margin. Ultrasonic energy pulses of approximately 2 sec were then applied to the tool tip 3 to cut and lift the soft tissue mass away from the bone cavity. Tool tip 3 was progressively advanced under the soft tissue mass until the tissue mass was completely separated from the bone. Water was sprayed from the irrigation spout 20 to a position near the surgical site during each ultrasonic pulse to cool the tool tip 3 and flush the surgical site.

Ultrasonic Periosteal Elevator

Diseased gingival tissue surrounding the root canal was first incised with a scalpel to allow the prototype ultrasonic periosteal elevator to reflect the periosteum. The size of the prototype ultrasonic periosteal elevator as shown in FIG. 4 was selected based on the type and size of the incision. The treatment section 25 of the ultrasonic periosteal elevator was positioned at the margin of the diseased soft tissue and a slight pressure exerted towards the underlying bone. Ultrasonic energy pulses of approximately 2 sec were then applied to the treatment section 25 to elevate and reflect the soft tissue from the underlying bone until the surgical site was adequately exposed. Water was sprayed from the irrigation spout 20 to a position near the surgical site during each ultrasonic pulse to cool the tool tip 5 and flush the surgical site.

From the above tests, several conclusions were made. The ultrasonic periosteal elevator passed easily between the periosteum and the bone while cutting blood vessels cleanly without tearing. Upon completion of the surgical procedure, the periosteum was sufficiently intact to allow the surgeon to reposition it on the bone and suture it in place. The ultrasonic curette passed easily between the soft tissue and underlying bone such that upon completion of the surgical procedure, the surgeon was able to obtain an intact specimen of pathologic tissue for biopsy evaluation. The remaining tissue was repositioned and sutured in place.

### EXAMPLE 5

Future Testing of the Ultrasonically-Actuated Surgical Devices

Prototypes of the ultrasonic bone remover, ultrasonic tooth cutter, ultrasonic root elevator, and ultrasonic root tip elevator will be constructed similar to the description in Example 3. Once constructed, clinical trials will be conducted to determine the effectiveness of these prototypes in abrading away portions of a bone and tooth in minimizing the generation of frictional heat and the potential for clogging, separating periodontal ligament fibers from a root surface and the bony housing surrounding the root, and extracting teeth while insulating the surrounding body masses from ultrasonic vibration and heat.

Ultrasonic Bone Remover

An ultrasonic bone remover is used to remove cortical bone to gain access to the surgical treatment area beneath the underlying bone. The treatment section 14 of the prototype ultrasonic bone remover as shown in FIG. 1 will be positioned against the cortical bone and light pressure applied. Ultrasonic energy pulses of approximately 2-3 sec will then be applied to the tool tip 1 to abrade away portions of the cortical bone. Water from the irrigation spout 7 will be sprayed to a position near the surgical site during each ultrasonic pulse to cool the tool tip 1 and flush the surgical site. Suction will be used to remove debris and blood produced as the bone is removed. This process will be repeated until the size of the hole in the cortical bone sufficiently exposes the surgical treatment area.

Ultrasonic Tooth Cutter

An ultrasonic tooth cutter is used to bevel the tip of the root in order to prepare the root for placement of a filling material (e.g., silver amalgam, gutta percha, cements based on zinc oxide eugenol, composite materials, mineral trioxide aggregate, etc.) to seal the open cavity and inhibit the reoccurrence of infection. The treatment section 16 of a prototype ultrasonic tooth cutter as shown in FIGS. 2A and 2B will have a shape similar to a commercially available bur (e.g., a round end tapered diamond S. Course #5805-016 and a flat end cylinder diamond S. Course #5835-010 burs; Brassler USA, Savannah, Ga.). To bevel the root, the treatment section 16 will be first positioned on the lateral surface of the root, approximately 2-3 mm from the tip. Ultrasonic energy will then be applied continuously to tool tip 2 as it is advanced and retracted to cut through the dentin of the root tip. Water will be continuously sprayed from the irrigation spout 7 to a position near the surgical site to cool the tool tip and flush the surgical site. The procedure will be continued until the root has been completely cross-sectioned.

Ultrasonic Root Elevator

A prototype ultrasonic root elevator as shown in FIG. 5 having a treatment section 27 similar in shape to a commercially available manual elevator (e.g., a Seldin #34 or 34S, Hu-Friedy, Chicago, Ill.) will be used to extract the root of a tooth that has been sectioned. The treatment section 27 will be placed so its cutting surface is against the root to be delivered and the noncutting surface 26, which is insulated with a dampener 28, is rested on the other tooth segment or bone. The dampener 28 will prevent ultrasonic damage to bone or other vital tissues in the surgical site. Rotational pressure will then be manually applied to the treatment section and 34 sec bursts of high intensity ultrasonic energy will be applied to separate the fibers of the periodontal ligament and deliver the root Water will be sprayed from the irrigation spout 20 to a position near the surgical site during each ultrasonic pulse to cool the tool tip 9 and flush the surgical site. The ultrasonic energy will separate the fibers of the periodontal ligament and deliver the root with less manual force than when compared with the classical approach. The cycle of rotational pressure and ultrasonic bursts will be repeated until the root is delivered.

Ultrasonic Root Tip Elevator

A prototype ultrasonic root tip elevator as shown in FIG. 6 having a treatment section 29 similar in shape to a commercially available elevator (e.g., #2 and #3 West; Hu-Friedy Dental Company, Chicago, Ill.) will be used to extract a fractured root. To remove the fractured root, the cutting surface of the treatment section 29 will be positioned between the broken root and the bony wall of the tooth socket. The noncutting surface 32 of the treatment section 29, which will be insulated with a dampener 28, will be rested against the socket wall to protect the bone. High intensity ultrasonic energy will then be applied to the treatment section 29 in 3-4 sec bursts. As energy is applied, the root tip will be manually elevated. Water will be sprayed from the irrigation spout 20 to a position near the surgical site during each ultrasonic pulse to cool the tool tip 11 and flush the surgical site. The cycle will be repeated until the root tip is loosed and removed.

The complete disclosures of all references cited in this specification are hereby incorporated by reference. In the event of an otherwise irreconcilable conflict, however, the present specification shall control.

What is claimed:

1. A surgical instrument for ultrasonic or sonic treatment, comprising a tool tip holder; and a tool tip having a fixation end and a treatment section, wherein said treatment section is adapted to perform a surgical function selected from the group consisting of reflecting periosteum from a tooth or a bone, abrading away at least a portion of a bone, cutting and lifting soft tissue mass in close proximity to a tooth or a bone, abrading away at least a portion of a tooth or a cartilage, beveling the root tip of a tooth, removing a root tip of a tooth, separating periodontal ligament fibers from a root surface and the bony housing surrounding a root while inhibiting the transfer of that to surrounding body masses, sectioning a tooth, and removing at least a portion of a tooth lodged in a root surface or bony housing surrounding a root while inhibiting the transfer of heat to surrounding body masses, wherein said tool tip holder is adapted to removably couple said tool tip holder to an ultrasonic or sonic vibrating member.

2. A surgical instrument as recited in claim 1, wherein said tool tip holder comprises a shaft comprising an attachment end, a coupling end, and an irrigation spout, wherein said coupling end is adapted to removably couple said tool tip holder to an ultrasonic or sonic vibrating member, wherein said irrigation spout is adapted to eject water supplied by the vibrating member to a location near a surgical site area during surgery, and wherein said attachment end is adapted to be permanently attached to said fixation end of said tool tip.

3. A surgical instrument as recited in claim 1, wherein said tool tip holder comprises a universal tip holder comprising an irrigation spout, a transmitting end, and a coupling end, wherein said transmitting end is adapted to be removably coupled to said fixation end of said tool tip, wherein said coupling end is adapted to be removably coupled to a sonic or ultrasonic vibrating member, and wherein said irrigation spout is adapted to eject water supplied by the vibrating member to a location near a surgical site area during surgery.

4. A surgical instrument as recited in claim 1, wherein said tool tip has a treatment section selected from the group consisting of a treatment section having the shape of a periosteal elevator, a curette, a bur, a round end tapered bur, a flat end cylinder bur, a round end bur, a root elevator, and a root tip elevator.

5. A surgical instrument as recited in claim 1, wherein said tool tip comprises a periosteal elevator adapted to reflect periosteum from a tooth or a bone.

6. A surgical instrument as recited in claim 1, wherein said tool tip comprises a curve- shaped bone cutter having a round end bur shape adapted to abrade away at least a portion of a bone.

7. A surgical instrument as recited in claim 1, wherein said tool tip comprises a straight- shaped bone cutter having a round end bur shape adapted to abrade away at least a portion of a bone.

8. A surgical instrument as recited in claim 1, wherein said tool tip comprises a curette adapted to lift and displace vascular soft tissue mass in close proximity to a tooth or a bone.

9. A surgical instrument as recited in claim 1, wherein said tool tip is a bur adapted to abrade away at least a portion of a tooth, a bone, or calcified cartilage.

10. A surgical instrument as recited in claim 9, wherein said bur is coated with cubic zirconia.

11. A surgical instrument as recited in claim 9, wherein said bur is coated with diamonds.

12. A surgical instrument as recited in claim 9, wherein said bur is coated with steel chips.

13. A surgical instrument as recited in claim 1, wherein said tool tip comprises a bur adapted to abrade away at least a portion of a tooth to form a beveled or flat tooth surface.

14. A surgical instrument as recited in claim 13, wherein said bur is coated with diamonds.

15. A surgical instrument as recited in claim 13, wherein said bur is coated with cubic zirconia.

16. A surgical instrument as recited in claim 13, wherein said bur is coated with steel chips.

17. A surgical instrument as recited in claim 1, wherein said tool tip is a root elevator comprising a cutting surface and a noncutting surface having a dampener; wherein said root elevator is adapted to separate periodontal ligament fibers from a root surface and the bony housing surrounding the root; and wherein said dampener is adapted to inhibit the transference of heat generated at the cutting surface to surrounding tissues, teeth, and bones.

18. A surgical instrument as recited in claim 1, wherein said tool tip is a root tip elevator comprising a cutting surface and a noncutting surface having a dampener; wherein said root tip elevator is adapted to remove at least a portion of a tooth lodged in the root surface or bony housing surround the root; and wherein said dampener is adapted to inhibit the transfer of heat generated at the cutting surface to surrounding tissues, teeth, and bones.

19. A surgical instrument as recited in claim 18, wherein said dampener is made from a material selected from the group consisting of ceramic, polytetrafluoroethylene, polyester, and polypropylene.

20. A surgical instrument as recited in claim 1, additionally comprising a sonic vibrating member adapted to transmit oscillations to said tool tip at a frequency between about 5,000 and about 20,000 Hz.

21. A surgical instrument as recited in claim 1, additionally comprising an ultrasonic vibrating member adapted to transmit oscillations to said tool tip at a frequency between about 20,000 and about 30,000 Hz.
